(19) United States
(12) Patent Application Publication
(10) Pub. No.: US 2008/0006580 A1
(43) Pub. Date: Jan. 10, 2008

(54) METHOD FOR REMOVING IMPURITIES FROM A FIBROUS SUSPENSION

(75) Inventors: Georg JAEGER, Wilhelmsdorf (DE); Reimund RIENECKER, Heidenheim (DE)

Correspondence Address: GREENBLUM & BERNSTEIN, P.L.C., 1950 ROLAND CLARKE PLACE, RESTON, VA, 20191, US

(73) Assignee: VOITH PATENT GMBH, Heidenheim (DE)

(21) Appl. No.: 11/772,996

(22) Filed: Jul. 3, 2007

(30) Foreign Application Priority Data
Jul. 4, 2006 (DE) 10 2006 030 905.7

(51) Int. Cl. B01D 61/14; B01D 19/00

(52) U.S. Cl. 210/650; 210/188

(57) ABSTRACT

Method and apparatus for removing impurities from a fibrous suspension. The method includes conducting a fibrous suspension stream into an inflow chamber of a pressurized screen, concentrating portions of the fibrous suspension stream to be removed in front of a screen basket, discharging the concentrated portions in an overflow stream, passing an other portion of the fibrous suspension stream through the pressurized screen as a throughput stream, and guiding gases out of a central region of the housing of the pressurized screen. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of German Patent Application No. 10 2006 030 905.7 filed Jul. 4, 2006, the disclosure of which is expressly incorporated by reference herein in its entirety.

### BACKGROUND OF THE INVENTION

1. Field of the Invention

The invention relates to a method for removing impurities from a fibrous suspension. The fibrous suspension stream is conducted into an inflow chamber of a pressurized screen, such that portions to be removed are concentrated before a screen basket and discharged in an overflow stream, while other portions of the fibrous suspension leaves the pressurized screen as a throughput stream.

2. Discussion of Background Information

A separation process of the type generally discussed above is used for removing undesirable accompanying materials, so-called foreign particles, in particular, from a fibrous suspension suitable for paper production. As is known, fibrous suspensions that are to be used for paper production, in particular, those that have been obtained from recovered paper, often contain a greater or lesser quantity of foreign particles that have to be removed in the preparation plant. Screening devices, which are called screens or pressurized screens, have proven to be particularly expedient for this purpose.

In a pressurized screen, the suspension is divided into at least two fractions at a wire, namely a throughput, which contains the materials that have passed through the wire and an overflow with the substances that were rejected because of their size. In methods of this type, the fibers reach the throughput as cleaned accepted stock suspension. The large amount of water contained thereby preferably also goes into the throughput so that the overflow is or becomes thickened.

With a very small amount of overflow, this thickening can cause difficulties in the removal from the wire area. In addition to the disadvantage of the limited operational reliability of the pressurized screen, part of the wire can become so clogged that hardly any throughput develops there. However, drawing off relatively small amounts of overflow is often precisely what is desired, e.g., when no further screening step is provided for the overflow in the screening of foreign particles. Moreover, with modern, highly efficient pressurized screens the trend is towards larger wires with fine openings and smaller overflow rates, which further exacerbates the problem of overflow thickening. If this is compounded by greater quantity fluctuations in the throughput through the pressurized screen, some screens can no longer be operated in a satisfactory manner.

A method is known from DE 101 25 975 in which part of the overflow is guided back into the intake of the pressurized screen.

### SUMMARY OF THE INVENTION

The present invention provides a more operationally reliable method. Further, the invention allows return streams to be guided simply and easily back into the pressurized screen.

Accordingly, the invention includes guiding gases out of a central region of the pressurized screen housing. Further, according to an aspect of the invention, the gasses are not guided out of the center of the housing.

Typically, a return stream is diverted from the overflow stream as a recirculation portion. A return stream of this type improves the reliable-operation of the pressurized screen. It is advantageous that the overflow can be adjusted to those quantities at which an adequate discharge rate of the overflow is guaranteed without inadmissible losses of effectiveness or stock losses occurring: the excess of overflow is guided back into the separation process again. A safety margin for the overflow amount to compensate for fluctuations in throughput rates can also be realized without any difficulty. However, it is also easily possible to control the quantity of the recirculation portion such that the overflow quantity remains constant or is kept above a set minimum value even with changed throughput conditions.

In special cases the return stream can also be divided from the throughput stream.

The type of addition of the return stream according to the invention makes it possible to deaerate the content of the screen with simple devices as well as to introduce the return stream in an optimal manner. This arrangement means that the return stream can be added again particularly favorably without a separate pump, since a very low pressure prevails in the center of the screen. In the case of a vertically positioned screen, gases and light particles accumulate directly under the cover and can flow off into a recirculation adapter piece connected to the cover.

Accordingly, the present invention is directed to a method for removing impurities from a fibrous suspension. The method includes conducting a fibrous suspension stream into an inflow chamber of a pressurized screen, concentrating portions of the fibrous suspension stream to be removed in front of a screen basket, discharging the concentrated portions in an overflow stream, passing an other portion of the fibrous suspension stream through the pressurized screen as a throughput stream, and guiding gases out of a central region of the housing of the pressurized screen.

According to a feature of the invention, the gases are not guided through a center of the housing.

In accordance with another feature of the invention, the method can further include guiding a return stream into a center of the inflow chamber of the pressurized screen, such that the gases are not guided through a center of the housing.

According to the invention, the return stream can be composed of at least a part of the overflow stream. Further, the method can include forming a reject stream with an other part of the overflow stream, and removing reject stream and thereby undesirable foreign particles within the reject stream.

In accordance with still another feature of the instant invention, during operation of the pressurized screen, the overflow stream can be thickened and the throughput stream can become thinner. Moreover, at least a portion of the overflow forms a return stream to be guided back into the pressurized screen, and the return stream is set to be at least large enough that the thickening of the overflow stream remains so slight in all operating conditions that it flows off unimpeded from the pressurized screen.

According to a further feature of the invention, a flow of gas may be guided out of the central region of the housing. Further, the gas may include air.

According to the invention, the screen basket may include a cylindrical wire basket with slot-shaped wire openings.

The method can also include adjusting a division of the overflow stream with a regulator that controls a corresponding distribution device.

Further, according to the invention, the return stream can be guided in a pipe arranged outside the housing.

Still further, a recirculation adapter piece is mounted in a center of a cover of the housing and is composed of a central return line, a surrounding concentric pipe length, and a deaeration line attached to the pipe length. The central return line and the pipe length open into the inflow chamber. Also, the gases can be removed tangentially from the pipe length. The deaeration line is oriented at a connection angle (α) with respect to a horizontal axis between 5° and 30°. The central return line may open into the inflow chamber with an axial distance (A) of 1 to 10 times an interior diameter of the return line from the pipe length. The axial distance can be between 2 and 5 times the interior diameter of the return line. Moreover, an interior diameter of the pipe length may be between 5% and 40% of an interior diameter of the housing in an area of the inflow chamber. The interior diameter of the pipe length can be between 10% to 20% of the interior diameter of the housing in the area of the inflow chamber. An interior diameter of the pipe length can be 150% to 400% of an interior diameter of the return line. Further still, an axial length of the pipe length is between 100 and 1000 mm.

Moreover, the present invention is directed to an apparatus for removing impurities from a fibrous suspension. The apparatus includes an inflow chamber of a pressurized screen, a housing surrounding the inflow chamber, a rejects discharge for a reject portion of the fibrous suspension with impurities to be removed, a throughput stream discharge for a portion of the fibrous suspension passing through the pressurized screen, and a gas discharge element arranged to guiding gases out of a central region of the housing.

According to a feature of the invention, the apparatus can further include a return stream device structured and arranged to guide a portion of the reject portion into a center of the inflow chamber and the gas discharge element is arranged so the gases are not guided through a center of the housing.

In accordance with still yet another feature of the present invention, the apparatus can further include a recirculation adapter piece mountable in a center of a cover of the housing and composed of a central return line, a surrounding concentric pipe length, and a deaeration line attached to the pipe length. The central return line and the pipe length open into the inflow chamber.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an exemplary process description for the removal of foreign particles according to the invention;

FIG. 2 illustrates a detail of a pressurized screen according to the invention with mounted recirculation adapter piece;

FIG. 3 illustrates a recirculation adapter piece for carrying out the method in a view from above;

FIG. 4 illustrates a side view of a variant of the piece depicted in FIG. 2; and

FIG. 5 illustrates an alternative use of the coupling.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

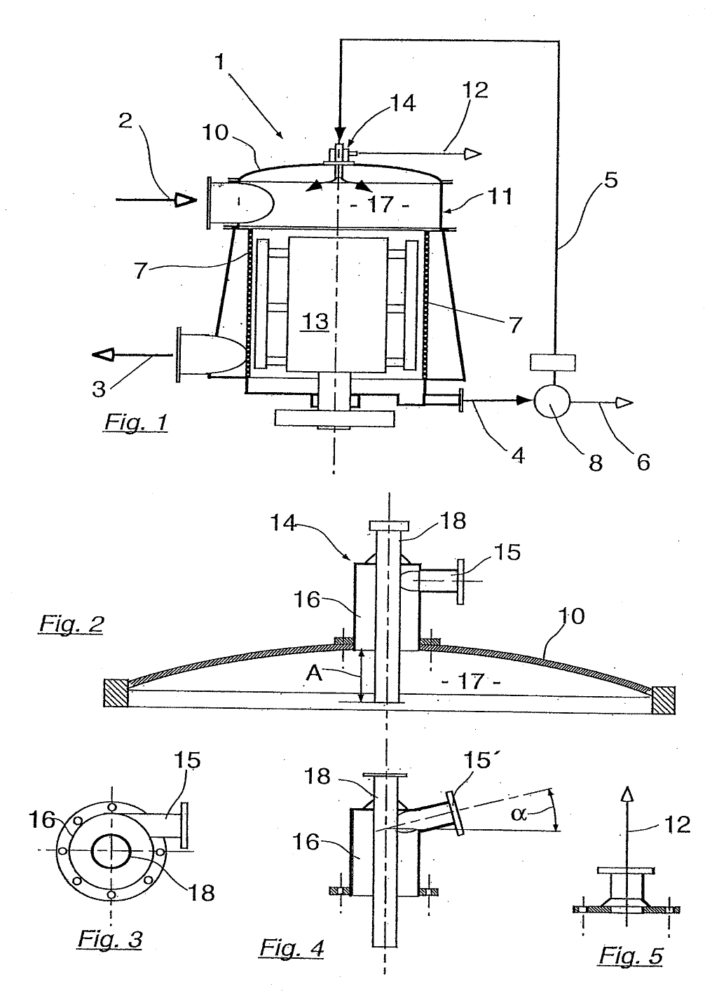

FIG. 1 shows a pressurized screen 1 in diagrammatic form. During the operation of a machine of this type, the fibrous suspension stream 2 flowing in is guided into the interior of the housing 11 and then passes radially from the inside outwardly, in part, through the cylindrical wire basket 7. This wire basket can be provided with slot-shaped wire openings, the width of which is, e.g., between 0.08 and 0.5 mm. A throughput stream 3 and an overflow stream 4 are formed at the wire basket 7. Both streams can then leave the housing 11 again through pipe connections. In order to prevent the wire clogging, a rotating scraper 13 is located radially inside the wire basket 7. Pressurized screens of this type are known in many variations and do not need to be described in further technical detail. In the example shown here, the overflow stream 4 is divided in a distribution device 8. Due to the rotary motion that is generated inside the wire basket 7 by the scraper 13, the overflow stream 4 leaves the housing with an overpressure that makes it possible to guide the return stream 5 diverted from the overflow stream 4 back into the housing again without a further pump. To this end, a recirculation adapter piece 14, the function of which is explained based on FIG. 2, is located in the center of the cover, i.e., where a relatively low pressure prevails.

The recirculation adapter piece 14 is mounted concentrically with the housing 11 on the cover 10 arranged above, preferably screwed thereto via flanges. The return line 18 opens in the center of the recirculation adapter piece 14. The return line is enclosed by a concentrically arranged pipe length 16 to which the deaeration line 15 is connected, preferably tangentially (see FIG. 3). The gases, possibly light particles as well, can thus flow off from the inflow chamber 17 of the pressurized screen 1. The pipe length 16 is open to the inflow chamber 17 of the pressurized screen 1. The pipe length 16 can advantageously terminate inside at the cover 10, while the return line 18 opens at a distance A from the cover 10, which distance corresponds, e.g., to 1 to 5 times the inside diameter of the return line 18.

As FIG. 4 shows, the deaeration line 15′ can have a connection angle α with respect to the horizontal, which angle is greater than 0, e.g., is between 5 and 30°, whereby the gases accumulating at the top can be drawn off more easily.

It can be particularly favorable in practice to be able to choose between operation with or without return stream 5. It would then be easier to retool the pressurized screen by, e.g., attaching one of the recirculation adapter pieces described above or optionally an adapter piece shown in FIG. 5 that contains only one deaeration line 15. The fitting dimensions on the cover 10 are the same as with the recirculation adapter piece 14.

The method was described in the figures based on the example of a curved cover 10. However, the method is largely independent of the cover shape, so it can also be used with screens with a conical or flat cover. A curved or conical form is generally preferable.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for removing impurities from a fibrous suspension, comprising:
conducting a fibrous suspension stream into an inflow chamber of a pressurized screen;
concentrating portions of the fibrous suspension stream to be removed in front of a screen basket;
discharging the concentrated portions in an overflow stream;
passing an other portion of the fibrous suspension stream through the pressurized screen as a throughput stream; and
guiding gases out of a central region of the housing of the pressurized screen.

2. The method in accordance with claim 1, wherein the gases are not guided through a center of the housing.

3. The method in accordance with claim 1, further comprising guiding a return stream into a center of the inflow chamber of the pressurized screen, such that the gases are not guided through a center of the housing.

4. The method in accordance with claim 1, wherein the return stream is composed of at least a part of the overflow stream.

5. The method in accordance with claim 4, further comprising:
forming a reject stream with an other part of the overflow stream; and
removing reject stream and thereby undesirable foreign particles within the reject stream.

6. The method in accordance with claim 1, wherein, during operation of the pressurized screen, the overflow stream is thickened and the throughput stream becomes thinner.

7. The method in accordance with claim 6, wherein at least a portion of the overflow forms a return stream to be guided back into the pressurized screen, and the return stream is set to be at least large enough that the thickening of the overflow stream remains so slight in all operating conditions that it flows off unimpeded from the pressurized screen.

8. The method in accordance with claim 1, wherein a flow of gas is guided out of the central region of the housing.

9. The method in accordance with claim 8, wherein the gas comprises air

10. The method in accordance with claim 1, wherein the screen basket comprises a cylindrical wire basket with slot-shaped wire openings.

11. The method in accordance with claim 1, further comprising adjusting a division of the overflow stream with a regulator that controls a corresponding distribution device.

12. The method in accordance with claim 3, wherein the return stream is guided in a pipe arranged outside the housing.

13. The method in accordance with claim 1, wherein a recirculation adapter piece is mounted in a center of a cover of the housing and is composed of a central return line, a surrounding concentric pipe length, and a deaeration line attached to the pipe length, and
wherein the central return line and the pipe length open into the inflow chamber.

14. The method in accordance with claim 13, wherein the gases are removed tangentially from the pipe length.

15. The method in accordance with claim 13, wherein the deaeration line is oriented at a connection angle (α) with respect to a horizontal axis between 50 and 30°.

16. The method in accordance with claim 13, wherein the central return line opens into the inflow chamber with an axial distance (A) of 1 to 10 times an interior diameter of the return line from the pipe length.

17. The method in accordance with claim 16, wherein the axial distance is between 2 and 5 times the interior diameter of the return line.

18. The method in accordance with claim 13, wherein an interior diameter of the pipe length is between 5% and 40% of an interior diameter of the housing in an area of the inflow chamber.

19. The method in accordance with claim 18, wherein the interior diameter of the pipe length is between 10% to 20% of the interior diameter of the housing in the area of the inflow chamber.

20. The method in accordance with claim 13, wherein an interior diameter of the pipe length is 150% to 400% of an interior diameter of the return line.

21. The method in accordance with claim 13, wherein an axial length of the pipe length is between 100 and 1000 mm.

22. An apparatus for removing impurities from a fibrous suspension, comprising:
an inflow chamber of a pressurized screen;
a housing surrounding the inflow chamber;
a rejects discharge for a reject portion of the fibrous suspension with impurities to be removed;
a throughput stream discharge for a portion of the fibrous suspension passing through the pressurized screen; and
a gas discharge element arranged to guiding gases out of a central region of the housing.

23. The apparatus in accordance with claim 22, further comprising a return stream device structured and arranged to guide a portion of the reject portion into a center of the inflow chamber and the gas discharge element is arranged so the gases are not guided through a center of the housing.

24. The apparatus in accordance with claim 22, further comprising a recirculation adapter piece mountable in a center of a cover of the housing and composed of a central return line, a surrounding concentric pipe length, and a deaeration line attached to the pipe length,
wherein the central return line and the pipe length open into the inflow chamber.
